(19) United States
(12) Patent Application Publication
(10) Pub. No.: US 2025/0243362 A1
(43) Pub. Date: Jul. 31, 2025

(54) POLYCARBONATE/ACRYLONITRILE BUTADIENE STYRENE/POLYURETHANE BLENDS WITH IMPROVED HYDROLYTIC STABILITY

(71) Applicant: Covestro LLC, Pittsburgh, PA (US)

(72) Inventors: Marina Rogunova, Pittsburgh, PA (US); Kyli Martin, Bridgeville, PA (US); James P. Mason, Carnegie, PA (US); Bruce D. Lawrey, Seattle, WA (US)

(21) Appl. No.: 19/034,744

(22) Filed: Jan. 23, 2025

Related U.S. Application Data
(60) Provisional application No. 63/626,208, filed on Jan. 29, 2024.

(30) Foreign Application Priority Data
May 29, 2024 (EP) 24178916.3

(51) Int. Cl. C08L 69/00; B60R 13/02

(52) U.S. Cl. CPC C08L 69/00; B60R 13/02; C08L 2203/30; C08L 2205/025; C08L 2205/035

(57) ABSTRACT

Provided is a thermoplastic blend comprising: A) 50 to 90% by weight, of at least one polymer selected from the group consisting of aromatic polycarbonate, aromatic polyestercarbonate and aromatic polyester; B) a rubber-modified vinyl (co) polymer and C) 2 wt. % to 30 wt. %, of an aromatic polyester-based thermoplastic polyurethane (TPU) having a difference between Vicat softening temperature and Tg of 135° C. to 210° C., wherein the Vicat softening temperature is at least 120° C.; and optionally D) 0 wt. % to 2 wt. %, of one or more additives selected from the group consisting of flame retardants, antistatic agents, thermal stabilizers, lubricants, demolding agents, colorants, and compatibilizers, wherein wt. %, all instances, is based on weight of the thermoplastic blend. The inventive blends have improved hydrolytic stability compared to PC/TPU blends.

### CROSS REFERENCE TO RELATED APPLICATION

This application claims benefit of U.S. Provisional Application No. 63/626,208 filed Jan. 29, 2024, and EP 24178916.3 filed May 29, 2024, which are incorporated herein by reference in their entireties.

### FIELD OF THE INVENTION

The present invention relates in general to thermoplastic resins and more specifically to blends of polycarbonate (PC)/acrylonitrile-butadiene-styrene (ABS)/polyurethane (TPU) having improved hydrolytic stability compared to state-of-the-art PC/TPU blends.

### BACKGROUND OF THE INVENTION

Polycarbonate (PC) and poly(acrylonitrile-butadiene-styrene) (PC/ABS) blends are the material of choice for automotive applications in both interior and exterior trims, largely due to the combination of good processability and superior mechanical properties. There is an emerging trend for higher flow materials, in addition to existing stringent long term hydrolytic stability requirements. It is known in the art that humid environments can significantly alter the mechanical properties of PC and PC blends. These properties include impact strength, fracture strain tensile and flex moduli, and thermophysical properties such as glass transition temperature and viscosity. To respond to this need, and overcome hydrolytic stability deficiency, which is inherent characteristic of typical PC/TPU blends, developmental efforts have been under way to formulate a polycarbonate/acrylonitrile-butadiene-styrene/polyurethane (PC/ABS/TPU) blend which will meet these requirements.

Laughner in U.S. Pat. No. 5,369,154 describes a polycarbonate blend said to have good impact and flexural strength, good heat distortion and weldline properties, low gloss, and good solvent resistance. The blend is prepared by admixing with polycarbonate an aromatic polyester, an olefinic epoxide-containing modifier, and one or more members of the group consisting of a thermoplastic elastomer and a rubber-modified styrene/acrylonitrile copolymer. Optionally, a graft copolymer of the core-shell type may be used as an additional impact modifier.

U.S. Pat. Nos. 4,912,177 and 5,162,461 both issued to Skochdopole et al., are directed to binary thermoplastic polyblends made of a thermoplastic aromatic polycarbonate and a thermoplastic polyester polyol-based polyurethane (TPU). The polyblends are said to exhibit improved hydrocarbon solvent resistance and melt flow properties over polycarbonate resins.

Henton et al. in U.S. Pat. No. 5,219,933 disclose a thermoplastic blend based on polycarbonate, thermoplastic polyurethane, and an impact modifier. These resins are said to be suitable for preparing molded or shaped articles having excellent combinations of processability, heat resistance, flexibility, solvent resistance, and low temperature toughness.

U.S. Pat. No. 5,308,894 issued to Laughner describes a polycarbonate blend that is said to have good impact and flexural strength, good weldline properties, and good solvent resistance which is prepared by admixing with polycarbonate an aromatic polyester, an olefinic epoxide-containing modifier, and a thermoplastic elastomer. Optionally, a graft copolymer of the core-shell type and a rubber-modified styrene/acrylonitrile copolymer may be used as additional impact modifiers.

Guest et al. in U.S. Pat. No. 5,250,606 provide a thermoplastic polymer blend comprising a monovinylidene aromatic copolymer, an acetal polymer and a thermoplastic polycarbonate resin or a polyester resin derived from the reaction of a dicarboxylic acid and a glycol, and which may also optionally contain an elastomeric material such as a thermoplastic polyurethane or an elastomeric copolyester. The resulting polymer blends are said to have good processability and a beneficial combination of physical and chemical properties including thermal/dimensional stability, impact resistance, chemical resistance, and environmental stress crack resistance. The polymer blends are said to be suitable for use in the preparation of a variety of molded utilitarian articles having good appearance and paintability.

EP104,695 B1 issued to Frencken et al., discloses a polymer composition consisting of: A. 5-90% (wt) of one or more graft copolymers obtained by polymerizing 10-90 parts by weight of a monomer mixture consisting of 20-40% (wt) acryl compound, 60-80% (wt) vinylaromatic compound, and 0-20% (wt) of one or more other unsaturated compounds, in the presence of 10-90 parts by weight rubber; B. 0-70% (wt) of one or more copolymers obtained by polymerizing 60-80 parts by weight vinylaromatic compounds, 20-40 parts by weight acryl compounds, 0-20 parts by weight of one or more other unsaturated compounds; C. 5-90% (wt) of one or more polycarbonates; and D. 0.5-25% (wt) of one or more polyurethanes. In addition to a good gasoline resistance, this composition is also said to have particularly good processing characteristics.

Kodera et al, in JP 06,306,269 provide a composition composed of a polycarbonate resin and respective specific polyurethane, graft copolymer and copolymer at specific ratios, having excellent surface gloss, impact resistance and coating suitability and useful as automotive parts, etc. The composition is composed of (A) 30-85 pts. wt. of a polycarbonate resin, (B) 5-35 pts. wt. of a thermoplastic polyurethane having a skeleton derived from a polycarbonate diol or a polycarbonate diol and a polyester diol, (C) 15-60 pts. wt. of a graft copolymer produced by the graft copolymerization of an aromatic vinyl compound, a vinyl cyanide compound and an αβ-unsaturated carboxylic acid alkyl ester in the presence of a rubbery polymer and (D) 0-40 pts. wt. of a copolymer produced by copolymerizing an aromatic vinyl compound, a vinyl cyanide compound and at least one kind of αβ-unsaturated carboxylic acid alkyl ester as the copolymerization monomer.

To reduce or eliminate problems, therefore, a need exists in the art for polycarbonate/acrylonitrile-butadiene-styrene/polyurethane (PC/ABS/TPU) blends with enhanced stability compared to state of the art PC/TPU blends.

### SUMMARY OF THE INVENTION

Accordingly, the invention reduces or obviates problems inherent in the art by providing polycarbonate/acrylonitrile-butadiene-styrene/polyurethane (PC/ABS/TPU) blend resulting in a material that exhibits improved processing characteristics in terms of flow, together with superior hydrolytic performance. The invention provides PC/ABS/TPU blends with enhanced hydrolytic stability compared to state-of-the-art PC/TPU blends. The combination of improved hydrolytic stability, high flow and good low temperature ductility makes these blends extremely valuable in a variety of automotive interior applications. The combination of low gloss and enhanced flow properties enables more accurate grain replication and potential elimination of paint from the part. In addition, these blends exhibit improved foam adhesion without surface treatment due to their TPU content and increased surface polarity. Improved adhesion has been a long-sought need for skin and foam instrumental panel applications.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 (a), and 35 U.S.C. § 132 (a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first embodiment, the present invention is directed to a thermoplastic blend comprising: A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate; B. a rubber-modified vinyl (co) polymer of B.1) 80 wt. % to 95 wt. %, preferably 83 wt. % to 93 wt. %, more preferably 85 wt. % to 92 wt. %, based on the rubber-modified vinyl (co) polymer B, of structural units derived from at least one vinyl monomer, and B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units, wherein the rubber-modified vinyl (co) polymer B is (i) a disperse phase consisting of (i.1) with vinyl (co) polymer of structural units according to B.1 grafted rubber particles and (i.2) vinyl (co) polymer enclosed in the rubber particles as a separated disperse phase also from structural units according to B.1, and (ii) a rubber-free vinyl (co) polymer matrix not bound to the rubber particles and not enclosed in these rubber particles consisting of structural units according to B.1, and wherein the disperse phase according to (i) has an average diameter D50 measured by ultracentrifugation of 0.7 to 2.0 pm, preferably from 0.7 to 1.5 pm, in particular from 0.7 to 1.2.; and C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers, wherein wt. %, all instances, is based on weight of the thermoplastic blend. The inventive blends have improved hydrolytic stability compared to PC/TPU blends.

In a second embodiment, the present invention is directed to a process of producing the thermoplastic blend according to the previous paragraph, the process comprising blending A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate; B. a rubber-modified vinyl (co) polymer of B. 1) 80 wt. % to 95 wt. %, preferably 83 wt. % to 93 wt. %, more preferably 85 wt. % to 92 wt. %, based on the rubber-modified vinyl (co) polymer B, structural units derived from at least one vinyl monomer and B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units, wherein the rubber-modified vinyl (co) polymer B is (i) a disperse phase consisting of (i.1) with vinyl (co) polymer of structural units according to B.1 grafted rubber particles, and (i.2) vinyl (co) polymer enclosed in the rubber particles as a separated disperse phase also from structural units according to B.1, and (ii) a rubber-free vinyl (co) polymer matrix not bound to the rubber particles and not enclosed in these rubber particles consisting of structural units according to B.1, and wherein the disperse phase according to (i) has an average diameter D50 measured by ultracentrifugation of 0.7 to 2.0 pm, preferably from 0.7 to 1.5 pm, in particular from 0.7 to 1.2.; and C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers, wherein wt. %, all instances, is based on weight of the thermoplastic blend.

In a third embodiment, the present invention is directed to a plastic part comprising the thermoplastic blend according to one of the two previous paragraphs.

In a fourth embodiment, the present invention is directed to an automotive part comprising the plastic part of the previous paragraph.

In a fifth embodiment, the present invention is directed to an automotive interior part comprising the plastic part according to the previous paragraph.

### Component A

Aromatic polycarbonates and/or aromatic polyester carbonates suitable for use as component A are known in the literature or can be prepared by methods in the literature (for the preparation of aromatic polycarbonates see, for example, Schnell, “Chemistry and Physics of Polycarbonates”, Interscience Publishers, 1964 and U.S. Pat. No. 3,553,167, DE-A 2,232,877, U.S. Pat. No. 4,075,173, GB1552558, U.S. Pat. No. 4,311,823, DE-A 3,832,396; for the preparation of aromatic polyester carbonates, e.g., CA1173998). The preparation of aromatic polycarbonates is carried out, for example, by reacting diphenols with carbonic acid halides, preferably phosgene and/or with aromatic dicarboxylic acid dihalides, preferably benzenedicarboxylic acid dihalides, by the phase boundary method, optionally using chain terminators, for example monophenols and optionally using trifunctional or more than trifunctional branches, for example triphenols or tetraphenols. Likewise, a preparation via a melt polymerization process by reaction of diphenols with, for example, diphenyl carbonate is possible.

Diphenols for the preparation of the aromatic polycarbonates and/or aromatic polyester carbonates are preferably those of formula (I)

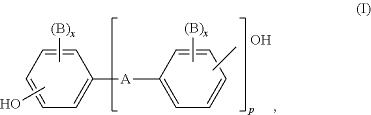

wherein
A is a single bond, C₁-C₅ alkylene, C₂-C₅ alkylidene, C₅-C₆ cycloalkylidene, —O—, —SO—, —CO—, —S—, —SO₂—, C₆-C₁₂ arylene, to which further aromatic optionally heteroatom-containing rings may be condensed,
   or a remainder of formula (II) or (III)

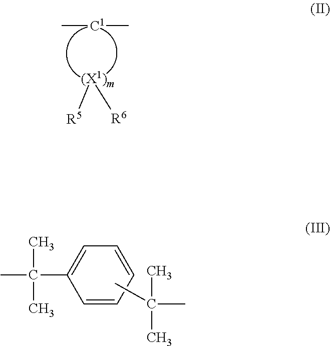

B in each case is C₁-C₁₂ alkyl, preferably methyl, halogen, preferably chlorine and/or bromine
x independently is 0, 1 or 2,
p is 1 or 0, and
R⁵ and R⁶ for each X¹ is independently hydrogen or C₁-C₆ alkyl, preferably hydrogen, methyl, or ethyl,
X¹ is carbon and
m is an integer from 4 to 7, preferably 4 or 5, with the proviso that at least one atom X¹, R⁵, and R⁶ is alkyl.

Preferred diphenols are hydroquinone, resorcinol, dihydroxydiphenols, bis (hydroxyphenyl-C₁-C₆ alkanes, bis (hydroxyphenyl)-C₅-C₆ cycloalkanes, bis (hydroxyphenyl) ether, bis (hydroxyphenyl) sulfoxides, bis (hydroxyphenyl) ketones, bis (hydroxyphenyl) sulfones and α,α-bis (hydroxyphenyl) diisopropylbenzenes and ring-brominated and/or ring-chlorinated derivatives thereof.

Particularly preferred diphenols are 4,4′-dihydroxydiphenyl, bisphenol-A, 2,4-bis (4-hydroxyphenyl)-2-methylbutane, 1,1-bis (4-hydroxyphenyl) cyclohexane, 1,1-bis (4-hydroxyphenyl)-3,3,5-trimethylcyclohexane, 4,4′-dihydroxydiphenyl sulfide, 4,4′-dihydroxydiphenyl sulfone and di- and tetrabrominated or chlorinated derivatives thereof, such as 2,2-bis (3-chloro-4-hydroxyphenyl) propane, 2,2-bis (3,5-dichloro-4-hydroxyphenyl)-propane or 2,2-bis-(3,5-dibromo-4-hydroxyphenyl)-propane. Particularly preferred is 2,2-bis (4-hydroxyphenyl) propane (bisphenol-A). The diphenols can be used individually or as any mixture. The diphenols are known to literature or available by methods known to the literature.

For the preparation of thermoplastic, aromatic polycarbonates suitable chain terminators are, for example, phenol, p-chlorophenol, p-tert-butylphenol or 2,4,6-tribromophenol, but also long-chain alkylphenols such as 4-[2-(2,4,4-trimethylpentyl)]-phenol, 4-(1, 3-tetramethylbutyl) phenol according to U.S. Pat. No. 4,269,964 or monoalkylphenol or dialkylphenols having a total of 8 to 20 carbon atoms in the alkyl substituents, such as 3,5-di-tert-butylphenol, p-iso-octylphenol, p-tert-octylphenol, p-dodecylphenol and 2-(3,5-dimethylheptyl) phenol and 4-(3,5-dimethylheptyl) phenol. The amount of chain terminators to be used is preferably between 0.5 mol % and 10 mol %, based on the molar sum of the diphenols used.

The thermoplastic, aromatic polycarbonates have average molecular weights (weight average M_{w}, measured by GPC (gel permeation chromatography) with polycarbonate standard based on bisphenol A) of preferably 20000 to 40000 g/mol, more preferably 24000 to 32000 g/mol, more preferably 26000 to 30000 g/mol. By the preferred areas is achieved in the inventive compositions a particularly advantageous balance of mechanical and rheological properties.

The thermoplastic, aromatic polycarbonates may be branched in a known manner, preferably by the incorporation of 0.05 to 2.0 mol %, based on the sum of the diphenols used, on three-fictional or more than three-factor compounds, for example those having three and more phenolic groups. Linear polycarbonates, more preferably based on bisphenol-A, are preferably used.

Both homopolycarbonates and copolycarbonates are suitable. For the preparation of inventive copolycarbonates according to component A, 1 to 25 wt. %, preferably 2.5 to 25 wt. %, Based on the total amount of diphenols to be used, polydiorganosiloxanes having hydroxyaryloxy end groups can be used. These are known (U.S. Pat. No. 3,419,634) and can be prepared by methods known in the literature. Also suitable are polydiorganosiloxane-containing copolycarbonates; the preparation of the polydiorganosiloxaneiger copolycarbonates is described, for example, in U.S. Pat. No. 4,584,360.

Compounds useful for the preparation of aromatic polyester carbonates are preferably the diacid dichlorides of isophthalic acid, terephthalic acid, diphenyl ether-4,4′-dicarboxylic acid and naphthalene-2,6-dicarboxylic acid.

Particularly preferred are mixtures of the diacid dichlorides of isophthalic acid and terephthalic acid in the ratio between 1:20 and 20:1.

In the preparation of polyester carbonates, a carbonic acid halide, preferably phosgene, is additionally used as a bifunctional acid derivative.

As chain terminators for the preparation of the aromatic polyester carbonates, in addition to the monophenols already mentioned, their chlorinated carbon dioxide esters and the acid chlorides of aromatic monocarboxylic acids, which may optionally be substituted by C₁-C₂₂ alkyl groups or by halogen atoms, and aliphatic C₂-C₂₂ monocarboxylic acid chlorides into consideration.

The amount of chain terminators is in each case 0.1 to 10 mol %, based in the case of phenolic chain terminators on mole diphenol and in the case of monocarboxylic acid chloride chain terminators on moles of dicarboxylic acid dichloride.

In the preparation of aromatic polyester carbonates, one or more aromatic hydroxycarboxylic acid can also be used. The aromatic polyester carbonates may be branched both linearly and in a known manner (see U.S. Pat. No. 4,334,053 and CA 1173998), wherein linear polyester carbonates are preferred.

Suitable branching agents can, for example, three- or multifunctional carboxylic acid chlorides such as trimesic acid trichloride, cyanuric acid trichloride, 3,3′-, 4,4′-benzophenone-tetracarboxylic acid tetrachloride, 1,4,5,8-napthalenetetracarboxylic acid tetrachloride or pyromellitic acid tetrachloride, in amounts of 0.01 to 1.0 mol % (based on dicarboxylic acid dichlorides used) or three- or multifunctional phenols such as phloroglucinol, 4,6-dimethyl-2,4,6-tri-(4-hydroxyphenyl)-hept-2-ene, 4,6-dimethyl-2,4-6-tri-(4-hydroxyphenyl) heptane, 1,3,5-tri-(4-hydroxyphenyl)benzene, 1,1,1-tri-(4-hydroxyphenyl) ethane, tri-(4-hydroxyphenyl)-phenylmethane, 2,2-bis [4, 4-bis (4-hydroxyphenyl)-cyclohexyl]-propane, 2,4-bis (4-hydroxyphenyl-isopropyl) phenol, tetra-(4-hydroxyphenyl)-methane, 2,6-bis (2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane, 1,4-bis [4,4′-dihydroxytri-phenyl)-methyl]benzene, in amounts of 0.01 to 1.0 mol % based on diphenols used. Phenolic branching agents can be used with the diphenols; acid chloride branching agents can be used together with the acid dichlorides.

In the thermoplastic, aromatic polyester carbonates, the proportion of carbonate structural units can vary arbitrarily. Preferably, the proportion of carbonate groups is up to 100 mol %, in particular, up to 80 mol %, particularly preferably up to 50 mol %, based on the sum of ester groups and carbonate groups. Both the ester and the carbonate content of the aromatic polyester carbonates can be in the form of blocks or statistically distributed in the polycondensate.

The thermoplastic, aromatic polycarbonates and polyester carbonates can be used alone or in any mixture. Linear polycarbonate based exclusively on bisphenol A is preferably used as component A.

### Component B

Component B is a rubber-modified vinyl (co) polymer of
B.1) 80 wt. % to 95 wt. %, preferably 83 wt. % to 93 wt. %, more preferably 85 wt. % to 92 wt %, based on the rubber-modified vinyl (co) polymer B, structural units derived from at least one vinyl monomer and
B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units,
   wherein the rubber-modified vinyl (co) polymer B is:
(i) a disperse phase consisting of
   (i.1) with vinyl (co) polymer of structural units according to B.1 grafted rubber particles and
   (i.2) vinyl (co) polymer enclosed in the rubber particles as a separated disperse phase also from structural units according to B.1,
   and
(ii) a rubber-free vinyl (co) polymer matrix not bound to the rubber particles and not enclosed in these rubber particles consisting of structural units according to B.1,
   and wherein the disperse phase according to (i) has an average diameter, D50, measured by ultracentrifugation of 0.7 pm to 2.0 pm, preferably from 0.7 pm to 1.5 pm, in particular from 0.7 pm to 1.2 pm.

The glass transition temperature Tg is determined, unless expressly described otherwise in the present invention, for all components by means of differential scanning calorimetry (DSC) according to DIN EN 61006 (version of 1994) at a heating rate of 10 K/min with determination of the Tg as the center temperature (tangent method).

The rubber-modified vinyl (co) polymers according to component B have a melt flow rate (MVR), measured according to ISO 1133 (version of 2012) at 220° C. with a stamp load of 10 kg, of preferably 2 to 20 ml/10 min, more preferably 3 to 15 ml/10 min, in particular 4 to 8 ml/10 min. If mixtures of several rubber-modified vinyl (co) polymers are used as component B, the preferred MVR ranges are the mean value of the MVR of the individual components weighted over the mass fractions of the components in the mixture.

Such rubber-modified vinyl (co) polymers B are prepared, for example, by radical polymerization, preferably in the mass polymerization process, of
B.1 80 wt. % to 95 wt. %, preferably 83 wt. % to 93 wt. %, particularly preferably 85 wt. % to 92 wt. %, based on the rubber-modified vinyl (co) polymer B, at least one vinyl monomer in the presence of
B.2 5 wt. % to 20 wt. %, preferably 7 wt. % to 17 wt. %, particularly preferably 8 wt. % to 15 wt. %, based on the rubber-modified vinyl (co) polymer B, of one or more rubber-elastic graft bases with glass transition temperatures <−50° C., preferably <−60° C., particularly preferably <−70° C., containing at least 50 wt. %, preferably at least 70 wt. %, particularly preferably 100 wt. % based on B.2, of structural units derived from 1,3-butadiene.

In the mass polymerization process used for the preparation of the rubber-modified vinyl (co) polymer B, both the polymerization of the vinyl monomers according to B.1 and a grafting of the resulting vinyl (co) polymer onto the rubber-elastic graft base according to B.2. Furthermore, in this reaction formation by self-organization (phase separation) the formation of a disperse phase (i) consisting of
(1.1) rubber particles grafted with vinyl (co) polymer from structural units according to B.1 and
(1.2) vinyl (co) polymer enclosed in the rubber particles as a separate disperse phase also from structural units according to B.1,
   wherein this rubber-containing phase (i) is dispersed in a rubber-free vinyl (co) polymer matrix (ii) consisting of structural units according to B. 1 not bound to the rubber particles and not enclosed in these rubber particles.

The rubber-free vinyl (co) polymer (ii) can be dissolved in contrast to the other vinyl (co) polymer proportions in component B by suitable solvents such as acetone.

The size of the disperse phase (i) in the rubber-modified vinyl (co) polymers B thus prepared is adjusted via the conditions of reaction formation such as temperature and resulting viscosity of the polymer and shear by, for example, stirring.

The average particle size D50 is the diameter above and below which 50 wt.-% of the particles lie. It is, unless expressly described otherwise in the present invention, for all components by means of ultracentrifuge measurement (W. Scholtan, H. Lange, Colloid and Polymer Science, 250 (1972), 782-796).

The monomers B.1 are preferably mixtures consisting of
B.1.1 60 to 85 wt. preferably, 65 to 80 wt., more preferably, 70 to 78 wt., parts, each based on the sum of B.1.1 and B.1.2, styrene, and
B.1.2 15 to 40 wt.—preferably 20 to 35 wt., more preferably 22 to 30 wt.-Parts, each based on the sum of B.1.1 and B.1.2, acrylonitrile, and optionally.
B.1.3 0-10 wt., preferably 0-7 wt., more preferably 0-5 wt.-Parts methyl methacrylate or n-butyl acrylate, each based on 100 wt.-Parts as the sum of B.1.1 and B.1.2.

Preferred graft bases B.2 are diene rubbers containing butadiene, or mixtures of diene rubbers containing butadiene or copolymers of diene rubbers containing butadiene or mixtures thereof with other copolymerizable monomers (e.g., according to B.1.1 and B.1.2). Particularly preferred graft bases B.2 are produced by anionic polymerization using a lithium compound as polymerization catalyst. Particularly preferred as graft base B.2 is pure polybutadiene rubber. In a further preferred embodiment, B.2 is styrene-butadiene-block copolymer rubber. The component B preferably has a polybutadiene content of 5 to 18 wt.-%, more preferably from 7 wt. % to 15 wt. %, in particular from 8 wt. % to 13 wt.-%.

Particularly preferred rubber-modified vinyl (co) polymers according to component B are mass ABS polymers such as those described for example in U.S. Pat. No. 3,644,574 (=DE-OS 2,035,390) or in DE-OS 2,248,242 (=GB-PS 1,409,275) or in Ullmann's Encyclopedia of Chemical Technology, Vol. 19 (1980), p. 280 ff. are described.

The not chemically bound to the rubber base(s) B.2 and the not enclosed in rubber particles vinyl (co) polymer (ii) can be formed as shown above due to the production during the polymerization of graft polymers B. It is also possible that a part of this not chemically bound to the rubber base(s) B.2 and not included in the rubber particles vinyl (co) polymer (ii) in the rubber-modified vinyl (co) polymer according to component B is formed due to production during its production in the mass polymerization process and another part is polymerized separately and added to component B as part of component B. The proportion of vinyl (co) polymer (ii), regardless of its origin, measured as an acetone-soluble portion, is in component B, based on component B, preferably at least 50 wt. %, particularly preferably at least 60 wt. %, more preferably at least 70 wt. %.

This vinyl (co) polymer (ii) has in the rubber-modified vinyl (co) polymers according to component B a weight-averaged molecular weight M_{w} from 70 to 250 kg/mol, preferably from 130 to 200 kg/mol, in particular from 150 to 180 kg/mol.

The weight-averaged molecular weight M_{w} of vinyl (co) polymer (ii) in component B is measured in the present invention by gel permeation chromatography (GPC) in tetrahydrofuran against polystyrene as standard.

In various embodiments, Component B is preferably free of emulsifiers that are typically used in emulsion polymerization processes such as for example saturated fatty acids having 8 to 22 carbon atoms, resin acids, alkyl and alkylarylsulfonic acids, and fatty alcohol sulfates.

In certain embodiments, Component B may be a mixture of (a) an acrylonitrile-butadiene-styrene produced by an emulsion process and (b) an acrylonitrile-butadiene-styrene produced by a mass polymerization process, each in various amounts.

Component B preferably contains less than 100 ppm, more preferably less than 50 ppm, most preferably less than 20 ppm ions of alkali metals and alkaline earth metals. The component B preferably contains an amount greater than zero but less than 10 ppm, more preferably 0.01 ppm-5 ppm, most preferably 0.1 ppm-2 ppm of lithium. Suitable as component B rubber-modified vinyl (co) polymers are, for example, MAGNUM 3404, MAGNUM 3504, and MAGNUM 3904 from Trinseo S.A. (Luxembourg).

### Component C

Component C is an aromatic polyester-based thermoplastic polyurethane (TPU). The choice of the type of TPU is critical to the inventive blend. Although the use of an ether based TPU would provide acceptable hydrolysis resistance, such a TPU would be too susceptible to thermal oxidation and would degrade at the temperatures (approximately 280° C.) required for processing polycarbonate blends. Ester-based TPU's are capable of being processed at these temperatures without excessive degradation, but because of the additional requirements of good polymer flow, damping characteristics, noise reduction and impact resistance, not all ester based TPU's would be as effective in the blends.

Preferred thermoplastic polyurethanes include aromatic thermoplastic polyurethanes (TPUs) based on polyester polyols (e.g., polybutylene adipates and polycaprolactone polyols) and aliphatic thermoplastic polyurethanes based on polyester polyols. The preferred isocyanate is 4,4′-MDI. The preferred polyester is made by reacting 1,4-butanediol with adipic acid. Other adipates may be used such as ethylene adipate or hexanediol adipates or blends of different short chain diols with adipic acid such as ethylene glycol and butanediol with adipic acid. Thermoplastic polyurethanes and methods for making them are known in the art and are described in e.g., U.S. Pat. Nos. 5,925,697; 5,981,655; 6,294,637; 6,410,638; and 6,559,267. The thermoplastic polyurethane useful in the invention preferably has a Shore A hardness of from 85 to 97, a Shore D hardness of 35 to 55 and a Tg from −42 to −15° C. Preferred thermoplastic polyurethanes include, but are not limited to, TEXIN 245D, TEXIN 255D, TEXIN 260D, and TEXIN 288 (all from Covestro).

The present inventors surprisingly have found that those ester based thermoplastic polyurethanes with a combination of low glass transition temperature (Tg) and high Vicat softening temperature provide the best overall properties. If the glass transition temperature of the thermoplastic polyurethane is too high, it could result in brittle material with poor impact resistance at low temperatures. If the Vicat softening temperature is not high enough, the TPU will not resist the required processing temperatures without degradation. It was found that the glass transition temperature of the thermoplastic polyurethane should be ≤−15° C. and more ideally, ≤−25° C., while the Vicat softening should be >120° C. and more ideally >130° C. therefore the difference in temperature between the Vicat softening and Tg preferably should be 145° C. to 210° C. and more ideally 170° C. to 200° C. Component C is preferably included in amounts 2 wt. % to 30 wt. %, preferably 5 wt. % to 20 wt. %, the wt. % based on the wt. of the thermoplastic blend. 2 wt. % to 30 wt. %, of a polyurethane (TPU) having a difference between Vicat softening temperature and Tg of 135° C. to 210° C., preferably 170° C. to 200° C., wherein the Vicat softening temperature is at least 120° C.

### Component D

As component D, 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers may optionally be included.

The polymer additives or polymeric blend partners are preferably selected from the group consisting of lubricants and demolding agents, other stabilizers, colorants, compatibility mediation, further of component B different impact resistance modifiers, further from components A and B different polymeric components (for example, functional blending partners or graft polymers with core-shell structure prepared in the emulsion polymerization process) and fillers and fillers and reinforcing materials.

In the preferred embodiment, no fillers or reinforcing materials are contained in component D. More preferably, no polymeric blend partners different from component B are included. More preferably, no polymeric components different from components A and B are included. In a particularly preferred embodiment, neither fillers or reinforcing agents, nor polymeric blend partners different from component B are included. Most preferably, neither fillers or reinforcing agents, nor polymeric components different form component A and B are included.

As lubricants and demolding agents, fatty acid esters, particularly preferably fatty acid esters of pentaerythritol or glycerol, are used. Benzotriazoles are particularly preferably used as a UV stabilizer. Optional colorant compositions useful in the invention are organic and inorganic pigments and dyes, including soluble dyes. In addition, one or more other components, which can be divided into volatile and non-volatile components, may be included.

Non-volatile components include binders, fillers, and auxiliaries. These are usually only needed in very small quantities but are often indispensable for problem-free processing.

The volatile components are essentially liquids in which the colorants and possible other components are dissolved or dispersed. It can be organic, inorganic solvents or mixtures of several solvents. Often the solvent is water or a mixture of water and another solvent. Suitable organic solvents are, for example, ketones, esters, alcohols and aromatic or aliphatic hydrocarbons. It can also be used mixtures of several organic or inorganic solvents.

The non-volatile binders ensure that the colorants are anchored to the substrate so that the finished print resists stresses caused by abrasion, heat, and mechanical bending. Suitable binders for the colorants are, for example, nitrocellulose in combination with plasticizers, thermoplastic polyurethanes, thermoplastic polyesters, thermoplastic polycarbonates, and thermoplastic poly (meth) acrylates. It is also possible that different binders are combined, as described in DE 198 32 570 A1. It is also possible to form the binder (e.g., a polyurethane or an epoxy resin) during the application of the colorant composition by chemical reaction in situ.

The selection of suitable colorants is practically unrestricted, provided that sufficient temperature resistance is guaranteed. Suitable organic colorants include, for example, colorants from the azo, antharachinone, azoporphine, thioindigo, dioxazine, naphthalenetetracarboxylic acid or perylenetetracarboxylic acid series and phthalocyanine compounds. Suitable inorganic colorants include, for example, iron oxides, ultramarines, zinc sulfides, silicon dioxides, aluminum oxides, titanium oxides, nickel and chromium compounds, phosphorus-tungsten-molybdenum acid bronzes and carbon blacks. Colorants with special effects, such as metal oxide-coated mica pigments and metallic aluminum pigments, can also be used.

Particularly suitable colorants are those based on anthraquinone, on perinone, or on phthalocyanine, or those derived from such structures. Particularly preferred colorants are described in WO 2012/080395 A1. It is also possible to use the following as colorants: MACROLEX VIOLET 3R (CAS 61951-89-1; SOLVENT VIOLET 36), MACROLEX GREEN 5B (CAS 128-80-3; SOLVENT GREEN 3; C.I. 61565), AMAPLAST YELLOW GHS (CAS 13676-91-0; SOLVENT YELLOW 163; C:I: 58840), MACROLEX ORANGE 3G (CAS 6925-69-5; SOLVENT ORANGE 60; C.I. 564100), MACROLEX BLUE RR (CAS 32724-62-2; SOLVENT BLUE 97; C.I. 615290); KEYPLAST BLUE KR (CAS 116-75-6; SOLVENT BLUE 104; C.I. 61568), HELIOGEN BLUE types (e.g., HELIOGEN BLUE K 6911; CAS 147-14-8; PIGMENT BLUE 15:1; C.I. 74160), HELIOGEN GREEN types (e.g., HELIOGEN GREEN K 8730; CAS 1328-53-6; PIGMENT GREEN 7; C.I. 74260), and also MACROLEX GREEN G (CAS 28198 May 2; SOLVENT GREEN 28; C.I. 625580). If necessary, a filler can also be incorporated into the colorant composition.

Suitable fillers include carbonates, sulfates, silicates, and oxides. For example, magnesium, calcium and barium carbonate, calcium and barium sulfate, silicates and aluminosilicates and aluminum, titanium, and silicon oxides are well suited. Mixtures of these compounds can also be used.

### Preparation of the Blends of the Invention

Thermoplastic blends were prepared from the components A, B, C, and optionally D of the invention.

The thermoplastic blending compositions of the invention can be prepared, for example, by mixing the respective components in a known manner and melt-compounded at temperatures of preferably 200° C. to 320° C., more preferably at 240° C. to 310° C., most preferably at 260° C. to 300° C. in conventional aggregates such as internal kneaders, extruders and twin-shaft screws melt compounded and melt extruded. This process is commonly referred to as compounding in the context of this application.

The mixing of the individual components of the blends can be carried out in a known manner both successively and simultaneously, both at about 20° C. (room temperature) and at higher temperature. This means, for example, that some of the components can be dosed via the main feed of an extruder and the remaining components can later be fed via a side extruder in the compounding process.

The combination of improved hydrolytic stability, high flow and good low temperature ductility makes inventive blends extremely valuable for use in a variety of automotive interior applications. The combination of low gloss and enhanced flow properties enables more accurate grain replication and potential elimination of paint from the part. In addition, materials produced from the inventive blends exhibit improved foam adhesion without surface treatment due to their thermoplastic polyurethane content and increased surface polarity. Improved adhesion has been a long-sought need for skin and foam instrumental panel applications.

### Examples

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

The following materials were used in preparation of the Examples:

| Component | Description |
|---|---|
| PC-A | homopolycarbonate based on bisphenol A, having melt volume |
| | rate (“MVR”) at 300° C./1.2 kg of 12.5 cm³/10 min, commercially |
| | available from Covestro AG as MAKROLON 2408; |
| PC-B | a linear homopolycarbonate based on bisphenol-A, having melt |
| | flow rate of about 10-14 g/10 min (at 300° C., 1.2 kg) per ASTM D |
| | 1238 commercially available as MAKROLON 2608; |
| PC-C | a linear homopolycarbonate based on bisphenol-A, having melt |
| | flow rate of about 4-5.6 g/10 min (at 300° C., 1.2 kg) per ASTM D |
| | 1238, commercially available as MAKROLON 3208; |
| ABS-A | acrylonitrile butadiene styrene (ABS) commercially available from |
| | Ineos Styrolution Group GmBH as TERLURAN HI-10; |
| ABS-B | a high flow, self-colored acrylonitrile butadiene styrene (ABS) |
| | reduced by the mass (continuous process) ABS technology |
| | commercially available from Trinseo S.A. as MAGNUM 8391; |
| ABS-C | acrylonitrile butadiene styrene (ABS) commercially available from |
| | Ineos Styrolution Group GmBH as Novodur ABS Powder P60; |
| TPU A | aromatic polyester-based thermoplastic polyurethane grade with |
| | Shore A hardness of approximately 88, commercially available |
| | from Covestro AG as TEXIN 288; |
| SAN A | styrene-acrylonitrile copolymer having a melt flow rate of 12 g/ 10 |
| | min. (230° C./3.8 kg load) per ASTM D 1238, commercially |
| | available from Ineos as LUSTRAN DN50; |
| ADDITIVE A | octadecyl-3-[3,5-di-tert-butyl-4-hydroxyphenyl]propionate], |
| | commercially available from BASF as IRGANOX 1076; |
| ADDITIVE B | aluminum oxide, commercially available from Sasol North |
| | America Inc. as PURAL 200; |
| ADDITIVE C | aromatic polycarbodiimide antihydrolysis agent, commercially |
| | available from Rhein Chemie as STABAXOL P 66/D; |
| ADDITIVE D | bis(2,4-di-tert-butylphenol)pentaerythritol diphosphate stabilizer, |
| | commercially available from Ciba Specialty Chemicals |
| | Corporation as IRGAFOS 126; |
| ADDITIVE E | a long-chain ester of pentaerythritol, available from Emery |
| | Oleochemicals as LOXIOL HOB-7119; and |
| ADDITIVE F | a styrene/acrylic copolymer which includes maleic anhydride in its |
| | structure making anhydride groups available for reaction, |
| | commercially available from BASF as JONCRYL ADR-3400. |

Tables I and II summarize the components of the instant examples along with physical property testing results. Notched Izod impact energy was measured according to ISO 180-AT (ASTM D 256), ultimate elongation was measured according to ISO 527-2, width was measured according to ISO 527-2, modulus was measured according to ISO 527-2, ultimate tensile strength was measured according to ISO 527-2. Deflection temperature was measured according to ISO-75 (ASTM D 648). High speed puncture was measured according to ASTM D3763C. Melt volume rate was measured according to ISO 1133. Specular Gloss was measured according to ASTM D 523. Vicat softening temperature was measured according to ASTM D 1525.

As can be appreciated by reference to Table I, The present invention reduces or obviates problems inherent in the art by providing polycarbonate/acrylonitrile-butadiene-styrene/polyurethane (PC/ABS/TPU) blend resulting in a material that exhibits improved processing characteristics (high MVR values, please see Table 1 and 2) in terms of flow, together with good low-temperature ductility (High Speed Puncture @−30° C., and Izod Impact test) and superior hydrolytic performance. For some reason we are missing the graphs, illustrating a good hydrolytic stability of the blends. Could you please check my original submission and the supporting documentation?

As is apparent by reference to Table II, the current invention provides PC/ABS/TPU blends with enhanced hydrolytic stability compared to state-of-the-art PC/TPU blends. The combination of improved hydrolytic stability, high flow and good low temperature ductility makes these materials extremely valuable in a variety of automotive interior applications. The combination of low gloss (please see Table 2) and enhanced flow properties (MVR) enables more accurate grain replication and potential elimination of paint from the part. In addition, these materials exhibit improved foam adhesion without surface treatment due to their TPU content and increased surface polarity. Improved adhesion has been a long-sought need for skin and foam instrumental panel applications.

TABLE I

| Component | Ex. I-1 | Ex. I-2 | Ex. I-3 | Ex. I-4 | Ex. I-5 | |
|---|---|---|---|---|---|---|
| PC-A | 70.26 | 70.26 | 70.26 | 70.26 | 70.26 | |
| SAN-A | 3 | 0 | 0 | 0 | 0 | |
| ABS-A | 18.74 | 18.2 | 17.2 | 16.2 | 15.2 | |
| ABS-B | 3.96 | 0 | 0 | 0 | 0 | |
| ABS-C | 3 | 5 | 6 | 7 | 8 | |
| TPU-A | 0 | 5 | 5 | 5 | 5 | |
| Additive A | 0.2 | 0.2 | 0.2 | 0.2 | 0.2 | |
| Additive B | 0 | 0.25 | 0.25 | 0.25 | 0.25 | |
| Additive C | 0 | 0.25 | 0.25 | 0.25 | 0.25 | |
| Additive D | 0 | 0.1 | 0.1 | 0.1 | 0.1 | |
| Additive E | 0.74 | 0.74 | 0.74 | 0.74 | 0.74 | |
| Total | 100 | 100 | 100 | 100 | 100 | |
| ASTM D 3763 High Speed | 40.48 | 37.9 | 38.5 | 38.88 | 36.54 | |
| Puncture @−30° C.--total | | | | | | |
| energy, ft · lbf | | | | | | |
| High Speed Puncture @- | ductile/ | ductile/ | ductile/ | brittle | ductile/ | |
| 30° C. (ST1_1) break type | brittle | brittle | brittle | | brittle | |
| High Speed Puncture @- | ductile | brittle | ductile/ | ductile/ | brittle | |
| 30° C. (ST1_2) break type | | | brittle | brittle | | |
| High Speed Puncture @- | ductile/ | ductile/ | ductile | brittle | brittle | |
| 30° C. (ST1_3) break type | brittle | brittle | | | | |
| High Speed Puncture @- | ductile/ | brittle | brittle | ductile/ | ductile/ | |
| 30° C. (ST1_4) break type | brittle | | | brittle | brittle | |
| High Speed Puncture @- | brittle | ductile/ | ductile/ | ductile/ | ductile/ | |
| 30° C. (ST1_5) break type | | brittle | brittle | brittle | brittle | |
| IS180AT (−30° C. 2) IMPACT | 45.702 | 45.605 | 45.17 | 47.346 | 45.17 | |
| ENERGY_KJ/M²--impact | | | | | | |
| energy, kJ/m2 | | | | | | |
| Ultimate Elongation | 77.86 | 71.5 | 73.18 | 78.24 | 73.48 | |
| Modulus | 2112 | 2022 | 1948 | 1976 | 1928 | |
| Ultimate Tensile Strength | 49.54 | 46.8 | 46.62 | 46.58 | 45.78 | |
| Melt Flow Rate/Melt | 19.18 | 23.24 | 19.03 | 20.28 | 22.41 | |
| Volume Rate (cm³/10 min) | | | | | | |
| Deflection Temperature (° C.) | 101.75 | 97.9 | 98.9 | 98.55 | 98.05 | |
| Component | Ex. I-6 | Ex. I-7 | Ex. I-8 | Ex. I-9 | Ex. I-10 | Ex. I-11 |
| PC-A | 70.26 | 70.27 | 70.27 | 70.27 | 70.27 | 70.27 |
| SAN-A | 0 | 0 | 0 | 0 | 0 | 3 |
| ABS-A | 14.2 | 20.19 | 22.19 | 20.19 | 18.19 | 18.75 |
| ABS-B | 0 | 0 | 0 | 3 | 5 | 3.96 |
| ABS-C | 9 | 3 | 1 | 0 | 0 | 3 |
| TPU-A | 5 | 5 | 5 | 5 | 5 | 0 |
| Additive A | 0.2 | 0.2 | 0.2 | 0.2 | 0.2 | 0.2 |
| Additive B | 0 . . . 25 | 0.25 | 0.25 | 0.25 | 0.25 | 0.25 |
| Additive C | 0.25 | 0.25 | 0.25 | 0.25 | 0.25 | 0.25 |
| Additive D | 0.1 | 0.1 | 0.1 | 0.1 | 0.1 | 0 |
| Additive E | 0.74 | 0.74 | 0.74 | 0.74 | 0.74 | 0.74 |
| Total | 100 | 100 | 100 | 100 | 100 | 100 |
| ASTM D 3763 | 38.08 | 40.92 | 35.36 | 34.64 | 35.62 | 33.98 |
| High Speed | | | | | | |
| Puncture @- | | | | | | |
| 30° C.--total | | | | | | |
| energy, ft · lbf | | | | | | |
| High Speed | ductile/ | brittle | brittle | brittle | brittle | brittle |
| Puncture @- | brittle | | | | | |
| 30° C. (ST1_1) | | | | | | |
| break type | | | | | | |
| High Speed | ductile | brittle | brittle | brittle | brittle | brittle |
| Puncture @- | | | | | | |
| 30° C. (ST1_2) | | | | | | |
| break type | | | | | | |
| High Speed | ductile | brittle | brittle | brittle | brittle | brittle |
| Puncture @- | | | | | | |
| 30° C. (ST1_3) | | | | | | |
| break type | | | | | | |
| High Speed | brittle | brittle | brittle | brittle | brittle | ductile/ |
| Puncture @- | | | | | | brittle |
| 30° C. (ST1_4) | | | | | | |
| break type | | | | | | |
| High Speed | ductile/ | brittle | brittle | brittle | brittle | brittle |
| Puncture @- | brittle | | | | | |
| 30° C. (ST1_5) | | | | | | |
| break type | | | | | | |
| IS180AT (−30° C. | 47.094 | | | | | |
| 2) IMPACT | | | | | | |
| ENERGY_KJ/M²--impact | | | | | | |
| energy, kJ/m2 | | | | | | |
| Ultimate | 88.72 | 28.46 | 54.42 | 45.84 | 62.34 | 87.82 |
| Elongation | | | | | | |
| Modulus | 1886 | 2316 | 2254 | 2356 | 2338 | 2294 |
| Ultimate Tensile | 46.2 | 42.86 | 44.38 | 44.6 | 46.2 | 47.98 |
| Strength | | | | | | |
| Melt Flow Rate/Melt | 22.1 | | | | | |
| Volume Rate (cm³/10 min) | | | | | | |
| Deflection | 96.6 | | | | | |
| Temperature | | | | | | |
| (° C.) | | | | | | |

TABLE II

| Component | Ex. II-1 | Ex. II-2 | Ex. II-3 | Ex. II-4 | Ex. II-5 |
|---|---|---|---|---|---|
| PC A | 68.75 | 0 | 58.85 | 63.75 | 58.75 |
| PC B | 0 | 47.21 | 0 | 0 | 0 |
| PC-C | 0 | 9.49 | 6.6 | 0 | 0 |
| Release agent | 0.75 | 0.5 | 0.5 | 0.75 | 0.75 |
| ABS polymer A | 23.7 | 0 | 0 | 23.7 | 23.7 |
| ABS polymer B | 6 | 0 | 0 | 6 | 6 |
| Thermal stabilizer | 0.1 | 0 | 0 | 0.1 | 0.1 |
| TPU | 0 | 5 | 5 | 5 | 10 |
| Antioxidant A | 0.2 | 0.2 | 0.2 | 0.2 | 0.2 |
| Antioxidant B | 0 | 0.1 | 0.1 | 0 | 0 |
| SAN | 0 | 24 | 7 | 0 | 0 |
| Graft polymer | 0 | 11 | 0 | 0 | 0 |
| UV Stabilizer | 0.5 | 0.5 | 0.5 | 0.5 | 0.5 |
| ABBS Copolymer | 0 | 0 | 21 | 0 | 0 |
| Polysiloxane | 0 | 0 | 0.25 | 0 | 0 |
| Impact modifier | 0 | 2 | 0 | 0 | 0 |
| Total | 100 | 100 | 100 | 100 | 100 |
| Notched Izod at 23° C. | 12.8 | 13.9 | 14.7 | 12 | 12 |
| ⅛ in. thickness (ft · lb/in) | | | | | |
| Notched Izod at −20° C. | 11 | 4.4 | 13.6 | 9.9 | 9.7 |
| ⅛ in. thickness (ft · lb/in) | | | | | |
| Notched Izod at −30° C. | 10.9 | 4 | 12.5 | 10 | 9.3 |
| ⅛ in. thickness (ft · lb/in) | | | | | |
| High Speed Puncture | 40.7 | 35.8 | 42.7 | 39 | 38.2 |
| @23° C.- -total energy (ft · lbf) | | | | | |
| High Speed Puncture | 38.6 | 33.5 | 37.3 | 41.3 | 40.8 |
| @20° C.- -total energy (ft · lbf) | | | | | |
| High Speed Puncture | 41.9 | 34.6 | 38.6 | 42.6 | 39.2 |
| @30° C.- -total energy (ft · lbf) | | | | | |
| Specular Gloss at 20° C. | 76.2 | 5.8 | 2.8 | 89.7 | 88.7 |
| Specular Gloss at 60° C. | 98.4 | 37.9 | 18.5 | 101 | 101 |
| Specular Gloss at 85° C. | 98.3 | 81.9 | 62.6 | 98.3 | 98.8 |
| Deflection Temperature | 124.2 | 117.7 | 125.9 | 118.5 | 115.6 |
| (.455ST) (° C.) | | | | | |
| Deflection Temperature | 101.6 | 99.1 | 107.2 | 94 | 90 |
| (1.82ST) (° C.) | | | | | |
| Vicat (50NLD) softening | 125.6 | 119.5 | 131.2 | 114.4 | 106.9 |
| temperature (° C.) | | | | | |

| Component | Ex. II-6 | Ex. II-7 | Ex. II-8 | Ex. II-9 |
|---|---|---|---|---|
| PC A | 0 | 0 | 58.85 | 53.85 |
| PC B | 47.21 | 47.21 | 0 | 0 |
| PC-C | 9.49 | 9.49 | 6.6 | 6.6 |
| Release agent | 0.5 | 0.5 | 0.5 | 0.5 |
| ABS polymer A | 0 | 0 | 0 | 0 |
| ABS polymer B | 0 | 0 | 0 | 0 |
| Thermal stabilizer | 0 | 0 | 0 | 0 |
| TPU | 5 | 10 | 5 | 10 |
| Antioxidant A | 0.2 | 0.2 | 0.2 | 0.2 |
| Antioxidant B | 0.1 | 0.1 | 0.1 | 0.1 |
| SAN | 24 | 24 | 7 | 7 |
| Graft polymer | 11 | 11 | 0 | 0 |
| UV Stabilizer | 0.5 | 0.5 | 0.5 | 0.5 |
| ABBS Copolymer | 0 | 0 | 21 | 21 |
| Polysiloxane | 0 | 0 | 0.25 | 0.25 |
| Impact modifier | 2 | 2 | 0 | 0 |
| Total | 100 | 100 | 100 | 100 |
| Notched Izod at 23° C. | 14.9 | 15.4 | 13.5 | 13.3 |
| ⅛ in. thickness (ft · lb/in) | | | | |
| Notched Izod at −20° C. | 4.6 | 5.3 | 11.1 | 11.3 |
| ⅛ in. thickness (ft · lb/in) | | | | |
| Notched Izod at −30° C. | 3.7 | 4.5 | 10.9 | 11.2 |
| ⅛ in. thickness (ft · lb/in) | | | | |
| High Speed Puncture | 35.7 | 34.5 | 35.1 | 32.3 |
| @23° C.- -total energy (ft · lbf) | | | | |
| High Speed Puncture | 34.4 | 34.4 | 38 | 39.9 |
| @20° C.- -total energy (ft · lbf) | | | | |
| High Speed Puncture | 28 | 32.1 | 36.8 | 36.1 |
| @30° C.- -total energy (ft · lbf) | | | | |
| Specular Gloss at 20° C. | 15.6 | 8.5 | 5.3 | 3.9 |
| Specular Gloss at 60° C. | 57.4 | 49 | 36.5 | 28 |
| Specular Gloss at 85° C. | 88.1 | 85.6 | 82.2 | 74.2 |
| Deflection Temperature | 108.7 | 102.8 | 117.6 | 114.4 |
| (.455ST) (° C.) | | | | |
| Deflection Temperature | 85.6 | 78.2 | 91.6 | 82.6 |
| (1.82ST) (° C.) | | | | |
| Vicat (50NLD) softening | 108.8 | 101.7 | 116.1 | 108.8 |
| temperature (° C.) | | | | |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserves the right to amend the claims during prosecution to add features as variously described in this specification, and such amendments comply with the requirements of 35 U.S.C. § 112 (a), and 35 U.S.C. § 132 (a).

Various aspects of the subject matter described herein are set out in the following paragraphs:

In a first aspect, the invention is directed to a thermoplastic blend comprising: A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate; B. a rubber-modified vinyl (co) polymer of B.1) 80 wt. % to 95 wt. %, preferably 83 wt. % to 93 wt. %, more preferably 85 wt. % to 92 wt. %, based on the rubber-modified vinyl (co) polymer B, of structural units derived from at least one vinyl monomer, and B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units, wherein the rubber-modified vinyl (co) polymer B is (i) a disperse phase consisting of (i.1) with vinyl (co) polymer of structural units according to B.1 grafted rubber particles and (i.2) vinyl (co) polymer enclosed in the rubber particles as a separated disperse phase also from structural units according to B.1, and (ii) a rubber-free vinyl (co) polymer matrix not bound to the rubber particles and not enclosed in these rubber particles consisting of structural units according to B.1, and wherein the disperse phase according to (i) has an average diameter D50 measured by ultracentrifugation of 0.7 to 2.0 pm, preferably from 0.7 to 1.5 pm, in particular from 0.7 to 1.2.; and C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers, wherein wt. %, all instances, is based on weight of the thermoplastic blend.

In a second aspect, the invention is directed to the thermoplastic blend according to the previous, wherein the blend has improved hydrolytic stability compared to polycarbonate/thermoplastic polyurethane blends.

In a third aspect, the invention is directed to the thermoplastic blend according to one of the previous two paragraphs, wherein component A comprises aromatic polycarbonate.

In a fourth aspect, the invention is directed to the thermoplastic blend according to any one of the previous three paragraphs, wherein component B comprises acrylonitrile-butadiene-styrene.

In a fifth aspect, the invention is directed to the thermoplastic blend according to the previous paragraph, wherein the acrylonitrile-butadiene-styrene is produced by an emulsion process.

In a sixth aspect, the invention is directed to the thermoplastic blend according to the fourth aspect, wherein the acrylonitrile-butadiene-styrene is produced by a mass polymerization process.

In a seventh aspect, the invention is directed to the thermoplastic blend according to the fourth aspect, wherein component B comprises a mixture of a first portion of acrylonitrile-butadiene-styrene produced by an emulsion process and a second portion of acrylonitrile-butadiene-styrene produced by a mass polymerization process.

In an eighth aspect, the invention is directed to a plastic part comprising the thermoplastic blend according to any one of the previous seven paragraphs.

In a ninth aspect, the invention is directed to a process of producing the thermoplastic blend according to any one of the previous seven paragraphs, the process comprising A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate; B. a rubber-modified vinyl (co) polymer of B. 1) 80 wt. % to 95 wt. %, preferably 83 wt. % to 93 wt. %, more preferably 85 wt. % to 92 wt. %, based on the rubber-modified vinyl (co) polymer B, of structural units derived from at least one vinyl monomer and B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures, Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units, wherein the rubber-modified vinyl (co) polymer B is (i) a disperse phase consisting of (i.1) with vinyl (co) polymer of structural units according to B.1 grafted rubber particles, and (i.2) vinyl (co) polymer enclosed in the rubber particles as a separated disperse phase also from structural units according to B.1, and (ii) a rubber-free vinyl (co) polymer matrix not bound to the rubber particles and not enclosed in these rubber particles consisting of structural units according to B.1, and wherein the disperse phase according to (i) has an average diameter D50 measured by ultracentrifugation of 0.7 to 2.0 pm, preferably from 0.7 to 1.5 pm, in particular from 0.7 to 1.2.; and C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers, wherein wt. %, all instances, is based on weight of the thermoplastic blend.

In a tenth aspect, the invention is directed to the process according to the previous paragraph, wherein the thermoplastic blend has improved hydrolytic stability compared to polycarbonate/thermoplastic polyurethane blends.

In an eleventh aspect, the invention is directed to the process according to one of the previous two paragraphs, wherein component A comprises aromatic polycarbonate.

In a twelfth aspect, the invention is directed to the process according to any one of the previous three paragraphs, wherein component B comprises acrylonitrile-butadiene-styrene.

In a thirteenth aspect, the invention is directed to the process according to the previous paragraph, wherein the acrylonitrile-butadiene-styrene is produced by an emulsion process.

In a fourteenth aspect, the invention is directed to the process according to the twelfth aspect, wherein the acrylonitrile-butadiene-styrene is produced by a mass polymerization process.

In a fifteenth aspect, the invention is directed to the process according to the twelfth aspect, wherein component B comprises a mixture of a first portion of acrylonitrile-butadiene-styrene produced by an emulsion process and a second portion of acrylonitrile-butadiene-styrene produced by a mass polymerization process.

In a sixteenth aspect, the invention is directed to the plastic part comprising the thermoplastic blend made according to the process of any one of the previous seven paragraphs.

In a seventeenth aspect, the invention is directed to the automotive part comprising the plastic part according to one of the previous eight paragraphs.

In an eighteenth aspect, the invention is directed to the automobile interior part comprising the automotive part according to the previous paragraph.

What is claimed is:

1. A thermoplastic blend comprising:
A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate;
B. a rubber-modified vinyl (co) polymer of
B.1) 80 wt. % to 95 wt. %, preferably 83 wt. % to 93 wt. %, more preferably 85 wt. % to 92 wt. %, based on the rubber-modified vinyl (co) polymer B, of structural units derived from at least one vinyl monomer, and
B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units,
wherein the rubber-modified vinyl (co) polymer B is.
(i) a disperse phase consisting of
(i.1) with vinyl (co) polymer of structural units according to B.1 grafted rubber particles and
(i.2) vinyl (co) polymer enclosed in the rubber particles as a separated disperse phase also from structural units according to B.1, and
(ii) a rubber-free vinyl (co) polymer matrix not bound to the rubber particles and not enclosed in these rubber particles consisting of structural units according to B.1,
and wherein the disperse phase according to (i) has an average diameter D50 measured by ultracentrifugation of 0.7 to 2.0 pm, preferably from 0.7 to 1.5 pm, in particular from 0.7 to 1.2.; and
C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally
D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers,
wherein wt. %, all instances, is based on weight of the thermoplastic blend.

2. The thermoplastic blend according to claim 1, wherein the blend has improved hydrolytic stability compared to polycarbonate/thermoplastic polyurethane blends.

3. The thermoplastic blend according to claim 1, wherein component A comprises aromatic polycarbonate.

4. The thermoplastic blend according to claim 1, wherein component B comprises acrylonitrile-butadiene-styrene.

5. The thermoplastic blend according to claim 4, wherein the acrylonitrile-butadiene-styrene is produced by an emulsion process.

6. The thermoplastic blend according to claim 4, wherein the acrylonitrile-butadiene-styrene is produced by a mass polymerization process.

7. The thermoplastic blend according to claim 4, wherein component B comprises a mixture of a first portion of acrylonitrile-butadiene-styrene produced by an emulsion process and a second portion of acrylonitrile-butadiene-styrene produced by a mass polymerization process.

8. A plastic part comprising the thermoplastic blend according to claim 1.

9. A process of producing the thermoplastic blend according to claim 1, the process comprising blending
A) 50 wt. % to 90 wt. %, preferably 60 wt. % to 80 wt. %, particularly preferably from 65 wt. % to 75 wt. %, of at least one polymer selected from the group consisting of aromatic polycarbonate, aromatic polyestercarbonate and aromatic polyester, preferably aromatic polycarbonate;
B. a rubber-modified vinyl (co) polymer of
B.1) 80 wt. % to 95 wt. %, preferably 83 wt. % to 93 wt. %, more preferably 85 wt. % to 92 wt. %, based on the rubber-modified vinyl (co) polymer B, of structural units derived from at least one vinyl monomer and
B.2) 5 wt. % to 20 wt. %, preferably 7 wt. % to 17 wt. %, more preferably 8 wt. % to 15 wt. %, based on the rubber-modified vinyl (co) polymer B, of one or more rubber-elastic graft bases having glass transition temperatures, Tg<−50° C., preferably from <−60° C., particularly preferably <−70° C. containing at least 50 wt. %, preferably at least 70 wt. %, particularly preferably 100 wt. %, based on B.2, derived from 1,3-butadiene structural units,
wherein the rubber-modified vinyl (co) polymer B is.
(i) a disperse phase consisting of
(i.1) with vinyl (co) polymer of structural units according to B.1 grafted rubber particles, and
(i.2) vinyl (co) polymer enclosed in the rubber particles as a separated disperse phase also from structural units according to B.1, and
(ii) a rubber-free vinyl (co) polymer matrix not bound to the rubber particles and not enclosed in these rubber particles consisting of structural units according to B.1,
and wherein the disperse phase according to (i) has an average diameter D50 measured by ultracentrifugation of 0.7 to 2.0 pm, preferably from 0.7 to 1.5 pm, in particular from 0.7 to 1.2.; and
C) 2 wt. % to 30 wt. %, preferably 5 wt. % to 20 wt. %, of an aromatic polyester-based thermoplastic polyurethane (TPU) having a difference between Vicat softening temperature and Tg of 135° C. to 210° C., preferably 170° C. to 200° C., wherein the Vicat softening temperature is at least 120° C.; and optionally
D) 0 wt. % to 2 wt. %, preferably >0 wt. % to 1.5 wt. %, of one or more additives selected from the group consisting of flame retardants, antistatic agents, thermal stabilizers, lubricants, demolding agents, colorants, and compatibilizers,
wherein wt. %, all instances, is based on weight of the thermoplastic blend.

10. The process according to claim 9, wherein the thermoplastic blend has improved hydrolytic stability compared to polycarbonate/thermoplastic polyurethane blends.

11. The process according to claim 9, wherein component A comprises aromatic polycarbonate.

12. The process according to claim 9, wherein component B comprises acrylonitrile-butadiene-styrene.

13. The process according to claim 12, wherein the acrylonitrile-butadiene-styrene is produced by an emulsion process.

14. The process according to claim 12, wherein the acrylonitrile-butadiene-styrene is produced by a mass polymerization process.

15. The process according to claim 12, wherein component B comprises a mixture of a first portion of acrylonitrile-butadiene-styrene produced by an emulsion process and a second portion of acrylonitrile-butadiene-styrene produced by a mass polymerization process.

16. A plastic part comprising the thermoplastic blend made according to the process of claim 9.

17. An automotive part comprising the plastic part according to claim 8.

18. An automobile interior part comprising the automotive part according to claim 17.
